(19) United States
(12) Patent Application Publication
(10) Pub. No.: US 2020/0379562 A1
(43) Pub. Date: Dec. 3, 2020

(54) HAPTIC ACTUATOR ASSEMBLY HAVING A FLUID RESERVOIR

(71) Applicant: Immersion Corporation, San Jose, CA (US)

(72) Inventors: Simon FOREST, Montreal (CA); Vahid KHOSHKAVA, Montreal (CA)

(21) Appl. No.: 16/424,653

(22) Filed: May 29, 2019

(51) Int. Cl. G06F 3/01; B06B 1/18

(52) U.S. Cl. CPC G06F 3/016; B06B 1/183

(57) ABSTRACT

A haptic actuator assembly comprising a fluid reservoir and an actuator is presented. The fluid reservoir may hold a substantially non-compressible fluid, and has a first layer and a second layer that is less rigid than the first layer. The first layer has a first resonance frequency, and the second layer has a lower resonance frequency. The actuator is configured to cause a first vibration in which the first layer vibrates at the first resonance frequency and provides a first amount of displacement or acceleration. The fluid reservoir is configured to transfer a force of the first vibration from the first layer to the second layer to cause a second vibration in which the second layer vibrates at the lower resonance frequency and provides a second, higher amount of displacement or acceleration.

### FIELD OF THE INVENTION

The present invention is directed to a haptic actuator assembly having a fluid reservoir, and has application in gaming, consumer electronics, automotive, entertainment, and other industries.

### BACKGROUND

Haptics provide a tactile and force feedback technology that takes advantage of a user's sense of touch by applying haptic effects, such as forces, vibrations, and other motions to a user. Devices such as mobile devices, tablet computers, and handheld game controllers can be configured to generate haptic effects. Haptic effects can be generated with haptic actuators, such as a piezoelectric actuator.

### SUMMARY

One aspect of the embodiments herein relates to a haptic actuator assembly comprising a fluid reservoir and an actuator. The fluid reservoir is configured to hold a substantially non-compressible fluid, the fluid reservoir having a first layer disposed on a first side of the fluid reservoir, and having a second layer that is less rigid than the first layer and disposed on a second side of the fluid reservoir that is opposite of the first side, wherein the first layer has a first resonance frequency and the second layer has a second resonance frequency lower than the first resonance frequency. The actuator is mechanically coupled to the first layer of the fluid reservoir, the actuator being configured to cause a first vibration in which the first layer vibrates at the first resonance frequency and provides a first amount of displacement or acceleration of the first layer. The fluid reservoir, when filled with the substantially non-compressible fluid, is configured to transfer a force of the first vibration from the first layer to the second layer to cause a second vibration in which the second layer vibrates at the second resonance frequency and provides a second amount of displacement or acceleration of the second layer that is higher than the first amount of displacement or acceleration of the first layer.

### BRIEF DESCRIPTION OF THE DRAWINGS

The foregoing and other features, objects and advantages of the invention will be apparent from the following detailed description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1A depicts a block diagram of a haptic actuator assembly including an actuator and a fluid reservoir, according to an embodiment hereof.

FIG. 1B depicts a block diagram of a haptic-enabled device having a haptic actuator assembly, according to an embodiment hereof.

FIGS. 2A and 2B depict a haptic actuator assembly, according to an embodiment hereof, with FIG. 2A being a sectional view taken along line A-A of FIG. 2B.

FIGS. 3A and 3B depict a haptic actuator assembly having a mounting structure, according to an embodiment hereof, with FIG. 3A being a sectional view taken along line B-B of FIG. 3B.

FIGS. 4A and 4B depict a haptic actuator assembly having a rod for mechanical coupling, according to an embodiment hereof, with FIG. 4A being a sectional view taken along line C-C of FIG. 4B.

FIG. 5 depicts a haptic actuator assembly, according to an embodiment hereof.

FIGS. 6A and 6B depict a haptic actuator assembly having an object attached to a fluid reservoir, according to an embodiment hereof, with FIG. 6A being a sectional view taken along line D-D of FIG. 6B.

FIG. 7 depicts vibrations in a haptic actuator assembly, according to an embodiment hereof.

FIGS. 8-10 depict exploded views of various fluid reservoirs of respective haptic actuator assemblies, according to embodiments hereof.

FIGS. 11A and 11B depict a haptic actuator assembly having a fluid reservoir with an inlet, according to an embodiment hereof.

FIGS. 12A and 12B depict a partial sectional view and a perspective view, respectively, of a haptic actuator assembly having a fluid reservoir that tapers in size, according to an embodiment hereof.

FIG. 13 depicts a sectional view of a haptic actuator assembly having actuators in direct contact with a fluid, according to an embodiment hereof.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

One aspect of embodiments described herein relates to a haptic actuator assembly that has a fluid reservoir which is able to amplify displacement provided by a vibration, to provide an optimal resonance frequency for haptic effects, or a combination thereof. The haptic actuator assembly may include an actuator that is configured to generate an initial vibration, but the initial vibration may provide a low displacement (also referred to as a low amount of displacement) and/or a high frequency. The low displacement provided by the initial vibration may yield a low force for the initial vibration because the force of the initial vibration may be based on an acceleration associated with the initial vibration, with the acceleration being based in turn on the displacement provided by the initial vibration. Further, the initial vibration may occur at a resonance frequency of the actuator, but the resonance frequency of the actuator may in some instances be too high for a user to easily perceive. Thus, the actuator by itself may not be able to generate an effective haptic effect. Accordingly, embodiments of the haptic actuator assembly herein may convert an initial vibration from the actuator to another vibration that is more effective as a haptic effect. The latter vibration may be an output of the haptic actuator assembly, and may provide a higher displacement (also referred to as a high amount of displacement) and generate more force, and/or may have a lower frequency than the resonance frequency of the actuator so as to be easier for a user to perceive.

In an embodiment, a haptic actuator assembly may convert an initial vibration from an actuator to another vibration by at least transferring forces associated with the initial vibration from a first layer to a second layer, wherein the two layers have different properties. In an embodiment, the initial vibration of the actuator may cause a first vibration in which (or during which) the first layer vibrates, and the haptic actuator assembly may use fluid (e.g., water) as a medium that transfers a force(s) associated with the first vibration from the first layer to the second layer, so as to cause a second vibration in which (or during which) the second layer vibrates. For instance, the fluid may be contained in a fluid reservoir, and the first layer and second layer may form two opposite sides of the fluid reservoir. In such an instance, the fluid may provide fluid coupling between the first layer and the second layer, such that when the first layer vibrates, the fluid transfers a force(s) associated with the first layer's vibration to the second layer to cause the second layer to vibrate. More specifically, the first layer may act as an input layer to the fluid reservoir, and may be mechanically coupled to the actuator (e.g., via a solid object such as a rod) so that a force(s) associated with an initial vibration generated by the actuator is transferred to the first layer and causes the first layer to generate its own vibration, which may in some cases be referred to as a first vibration. The first vibration of the first layer may generate pressure pulses in the fluid, such that the fluid transfers or otherwise communicates a force associated with the first vibration of the first layer to the second layer, so as to cause the second layer to generate its own vibration, which in some cases may be referred to as a second vibration. As discussed in more detail below, the second vibration may in some instances be an output of the haptic actuator assembly.

In an embodiment, a second layer may be formed to be less rigid than a first layer. For instance, the first layer may be a metal diaphragm or a plastic diaphragm, while the second layer may be formed by a silicone layer having less rigidity than the metal or plastic diaphragm. In some cases, both the metal diaphragm and the silicone layer may be capable of undergoing sufficient elastic deformation to vibrate. In some situations, a rigidity (also referred to as stiffness) of the first layer or second layer may affect a resonance frequency or mode of vibration of that layer. For instance, if the second layer (e.g., silicone layer) has a lower rigidity than the first layer (e.g., metal diaphragm), the lower rigidity may contribute to the second layer having a lower resonance frequency relative to the first layer. Further in an embodiment, a higher rigidity of a first layer may also increase the likelihood that the first layer will vibrate at a lowest mode of resonance when excited at the resonance frequency of the first layer, while a lower rigidity of a second layer may increase the likelihood that the second layer will vibrate at a higher mode of resonance when excited at the resonance frequency of the second layer. In an embodiment, a lower rigidity of a second layer may contribute to an ability of the second layer (e.g., silicone layer) to vibrate with greater displacement relative to a first layer (e.g., metal diaphragm).

In an embodiment, a pressure of a fluid in a fluid reservoir may affect a displacement of a second layer (e.g., silicone layer) provided by a second vibration in which the second layer vibrates. For instance, the pressure of the fluid may be exerted on the second layer, and an increased pressure may increase tension in the second layer. The increased tension may lead to an increased amount of displacement by which the second layer vibrates at resonance during the second vibration, relative to a situation involving a lower pressure of the fluid. In an embodiment, a pressure of the fluid may affect a resonance frequency of a second layer. For instance, the increased pressure may lead to an increased resonance frequency. As stated above, a resonance frequency that is too high may render a vibration that is difficult to perceive. Thus, other properties of the second layer, such as its spring constant or mass, may have respective values which keep the resonance frequency of the second layer within a desirable range (e.g., 10 Hz to 250 Hz).

In an embodiment, a second layer (e.g., silicone layer) may have a lower spring constant and/or a higher mass relative to a first layer (e.g., metal diaphragm). In some situations, the lower spring constant and/or higher mass may contribute to the second layer having a lower resonance frequency than that of the first layer. In some situations, the resonance frequency of the second layer may further be lower than a resonance frequency of an actuator. For instance, the resonance frequency of the actuator may be greater than 1 KHz, while the resonance frequency of the second layer may be in a range of 10 Hz to 250 Hz. In such an instance, a haptic actuator assembly in accordance herewith may output a vibration (e.g., a second vibration in which the second layer vibrates) at the resonance frequency of the second layer (e.g., 100 Hz). The resonance frequency at which the second layer vibrates for the second vibration in this instance may be much easier to perceive relative to the resonance frequency of the actuator.

As stated above, an initial vibration of an actuator may create a force that is transferred to a first layer, resulting in a first vibration in which or for which the first layer vibrates. In an embodiment, a first layer may exhibit a nonlinear relationship between a force from the initial vibration of the actuator and a displacement of the first layer provided by the resulting first vibration. Further, the first vibration of the first layer may apply a force to a fluid of a reservoir. In this embodiment, the fluid coupling may also exhibit a nonlinear relationship between the force applied to the fluid by the first layer and a change in force or pressure in the fluid. Additionally, the change in force or pressure in the fluid may cause a second vibration in which the second layer vibrates, and there may also be a nonlinear relationship between the change in the force or pressure of the fluid and a displacement of the second layer provided by the resulting second vibration. The nonlinear relationships described above may contribute to amplifying displacement provided by an initial vibration generated by the actuator. More specifically, the nonlinear relationships may cause the initial vibration generated by the actuator to be converted to the first vibration of the first layer, and then to the second vibration of the second layer, wherein the fluid is used in the conversion, and wherein the vibration of the second layer provides a larger amount of displacement of the second layer than the displacement that is provided solely by the initial vibration of the actuator. As an example, the initial vibration generated by the actuator may, by itself, provide a displacement (e.g., of a housing of the actuator) that is on the order of microns, while a displacement of a second layer provided by the second vibration (which is an amplified vibration) may be on the order of millimeters. In an embodiment, a displacement provided by a vibration may refer to, e.g., a maximum amount of elastic deformation that a particular layer undergoes during the vibration. In one example, if the vibration creates a standing wave in a layer, a displacement may refer to an amplitude of the standing wave.

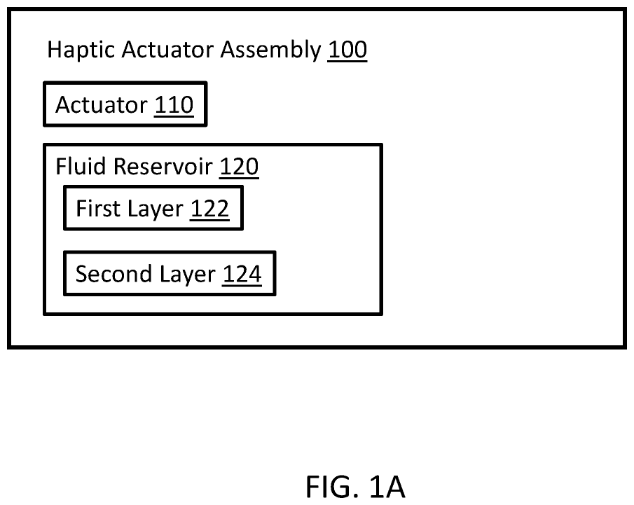

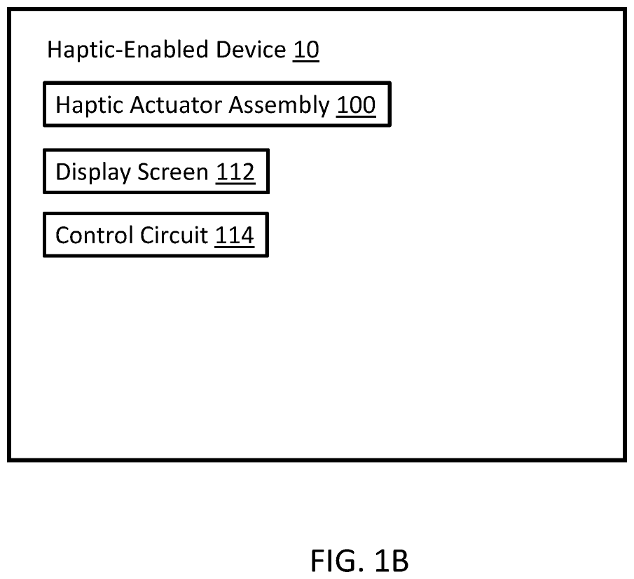

FIG. 1A depicts a block diagram of a haptic actuator assembly 100 that is configured to generate a haptic effect, such as a vibrotactile haptic effect. In the embodiment of FIG. 1A, the haptic actuator assembly 100 includes an actuator 110 and a fluid reservoir 120. As stated above, the actuator 110 may be configured to generate an initial vibration, which may have a force that is too low and/or a frequency that is too high to be an effective vibrotactile haptic effect. The fluid reservoir 120 may be configured to convert the initial vibration to another vibration (e.g., a second vibration) that has higher force and/or lower frequency. In some cases, the latter vibration may be output as the vibrotactile haptic effect of the haptic actuator assembly 100.

FIG. 1B depicts a block diagram of a haptic-enabled device 10 that incorporates the haptic actuator assembly 100. The haptic-enabled device 10 may be, e.g., a user interface device such as a mobile phone, laptop, vehicle entertainment console, or any other haptic-enabled device. In the embodiment of FIG. 1B, the haptic-enabled device 10 includes the haptic actuator assembly 100, a display screen 112, and a control circuit 114. The control circuit 114 may be, e.g., configured to act as a signal generator that generates and applies a driving signal to the haptic actuator assembly 100. In an embodiment, a control circuit 114 may include one or more processors, a digital signal processor (DSP), a field programmable gate array (FPGA), a programmable logic array (PLA), an amplifier circuit, or any combination thereof. As discussed below in more detail, the fluid reservoir 120 of the haptic actuator assembly 100 may include a first layer 122 and a second layer 124. In some cases, the driving signal may be a periodic signal (e.g., sinusoidal signal) having a frequency equal to a resonance frequency of the actuator 110 of the haptic actuator assembly 100, equal to a resonance frequency of the first layer 124 of the fluid reservoir 120 of the haptic actuator assembly 100, or equal to a resonance frequency of the second layer 124 of the fluid reservoir 120. In an embodiment, the haptic actuator assembly 100 may be in direct contact with the display screen 112, or more generally disposed adjacent to the display screen 112, and may generate a vibrotactile haptic effect for the display screen 112.

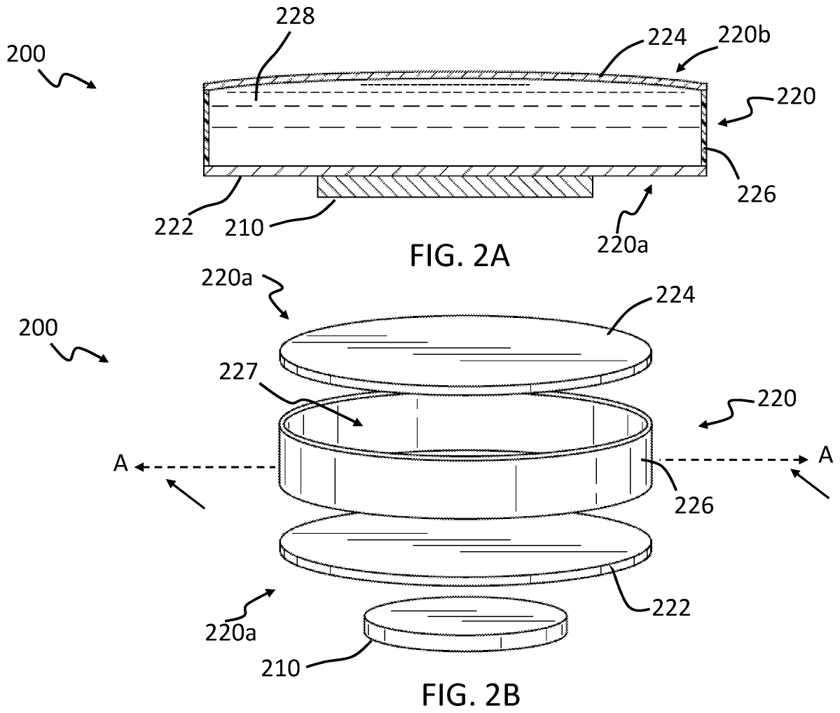

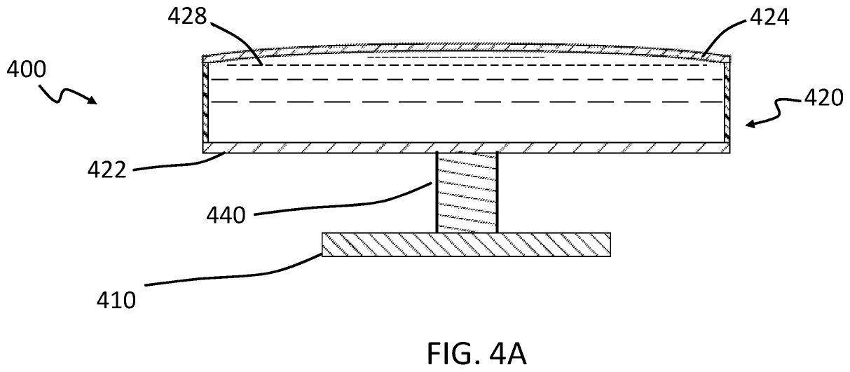

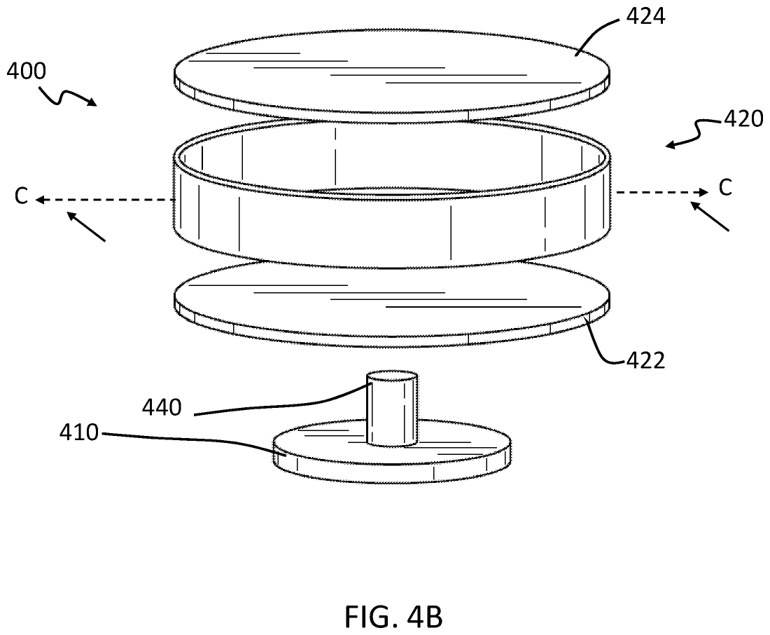

Returning to FIG. 1A, the fluid reservoir 120 may be configured to hold a substantially non-compressible fluid, and has the first layer 122 and the second layer 124. In an embodiment, the first layer 122 may be mechanically coupled to the actuator 110, and may act as an input layer of the fluid reservoir 120 that receives a force from an initial vibration generated by the actuator 110. Because the actuator 110 is mechanically coupled to the first layer 122, the initial vibration generated by the actuator 110 may cause a first vibration in which the first layer 122 vibrates (or, more generally, outputs displacement) in response to the force of the initial vibration. The mechanical coupling may be via direct contact between the actuator 110 and the first layer 122 (e.g., see FIGS. 2A and 2B) or via an intermediate object such as a rod (e.g., see FIGS. 4A and 4B). The first vibration of the first layer 122 may generate its own force. The force of the first vibration may be the same as or different in amplitude than the force of the initial vibration. The substantially non-compressible fluid may be configured to transfer the force of the first vibration from the first layer 122 to the second layer 124. The transferred force may create a second vibration in which the second layer 124 vibrates. In some cases, the second layer 124 may act as an output layer of the fluid reservoir 120.

In an embodiment, the first layer 122 may have a first resonance frequency, and the second layer 124 may have a second resonance frequency. In this embodiment, the first layer 122 may vibrate with a first amount of displacement at the first resonance frequency, while the second layer 124 may vibrate with a second amount of displacement at the second resonance frequency, wherein the second amount of displacement is higher than the first amount of displacement, and the second resonance frequency is lower than the first resonance frequency.

FIG. 2A illustrates a sectional view of a haptic actuator assembly 200, which may be an embodiment of the haptic actuator assembly 100. The sectional view in FIG. 2A is taken along the line A-A in FIG. 2B. FIG. 2B depicts an exploded view of the haptic actuator assembly 200. As depicted in FIGS. 2A and 2B, the haptic actuator assembly 200 includes an actuator 210 and a fluid reservoir 220. In an embodiment, the actuator 210 may be an embodiment of the actuator 110, and may be configured to generate a vibration (which may in some cases be referred to as an initial vibration) or other form of actuation. In some cases, the actuator 110 may include an actuatable material and electrodes disposed on opposite sides of the actuatable material. When a voltage difference is generated between the electrodes (e.g., by a driving signal), the actuatable material may be configured to generate displacement from an equilibrium position. In some cases, the displacement may have the form of a vibration or other form of actuation. In an embodiment, the actuator 210 may be a piezoelectric actuator or an electroactive polymer (EAP) actuator, such that the actuatable material is a piezoelectric material or an EAP material, respectively. In an embodiment, piezoelectric material may be a macrofiber composite (MFC) material, which includes piezo ceramic fibers embedded in a polymer, such that the actuator 210 is a MFC actuator. In an embodiment, the piezoelectric material may be a lead zirconate titanate (PZT) piezoelectric material. In some instances, the actuator 210 may be a TDK® PowerHap™ 15G piezo actuator. The TDK® PowerHap™ actuator is described in more detail in U.S. patent application Ser. No. 16/010,169, entitled “Haptic Actuator Assembly Having a Magnetic Pre-Load Device,” the entire content of which is incorporated by reference herein. In another embodiment, the actuator 210 may be an electromagnet actuator. In an embodiment, the actuator 210 may have a thickness that is in a range of 1 mm to 10 mm, or a range of 1 mm to 5 mm.

In an embodiment, the actuator 210 may be limited in how much displacement it can generate for an initial vibration of the actuator 210. For instance, the actuator 210 may be the TDK® PowerHap™ 15G piezo actuator, and may be formed from PZT material. The PZT material may undergo strain when a voltage difference is created across the material, and the strain may cause the material to undergo displacement and to vibrate as a result of the displacement. As stated above, the displacement may refer to a maximum amount of elastic deformation, or more generally a maximum amount of movement that the material undergoes. For instance, if the initial vibration generated by the actuator 210 involves a standing wave or other form of resonance of the PZT material, the displacement may refer to an amplitude of the standing wave, such as a peak-to-peak amplitude of an antinode of the standing wave. For the actuator 210, the displacement provided by the initial vibration may refer to, e.g., displacement of a housing of the actuator 210. If the actuator 210 includes the PZT material, it may rely on inducing strain in the PZT material to generate displacement of the housing of the actuator 210. The PZT material, however, may be able to undergo only a limited amount of strain before being damaged by too much strain. The limit on the amount of strain that the PZT material of the actuator 210 is able to undergo may thus limit the amount of displacement that the actuator 210 is able to generate. In an embodiment, the force generated by an initial vibration output by the actuator 210 may be based on an acceleration associated with the initial vibration, which in turn may be based on a displacement caused by the initial vibration. Because the amount of displacement provided by the initial vibration is low, the force associated with the initial vibration output by the actuator 210 may also be low. In an embodiment, the amount of displacement provided by a vibration of the actuator 210 may be limited to a range of, e.g., 1 μm to 10 μm, or a range of 10 μm to 100 μm, or a range of 50 μm to 500 μm.

In an embodiment, the actuator 210 may have a resonance frequency that is in a range of, e.g., 1 KHz to 10 KHz, or more generally a resonance frequency greater than 1 KHz. In some cases, the resonance frequency may be based on a material and structure of the actuatable material of the actuator 210. For instance, if the actuator 210 includes a layer of PZT material, the resonance frequency of the actuator 210 may be equal to or based on a resonance frequency of the PZT material.

In an embodiment, a frequency of a vibration may refer to a temporal frequency. For instance, if the vibration involves a standing wave having at least one antinode, the temporal frequency may describe how quickly the antinode oscillates around an equilibrium position (e.g., how many cycles per second). In some cases, an equation of the vibration may include a time-varying component, such as cos(2πft), and the frequency of the vibration may refer to a frequency of the time-varying component (e.g., f). In an embodiment, a resonance frequency of the actuator 210 (or of a first layer 222 or of a second layer 224) may also refer to a temporal frequency. If a frequency of vibration is at a resonance frequency, the vibration may be at a lowest mode of resonance (e.g, mode u_{0,1}) having only a single antinode, or may be at a higher mode of resonance (e.g., mode uo,2, uo,3, or u_{1,2}) having multiple antinodes.

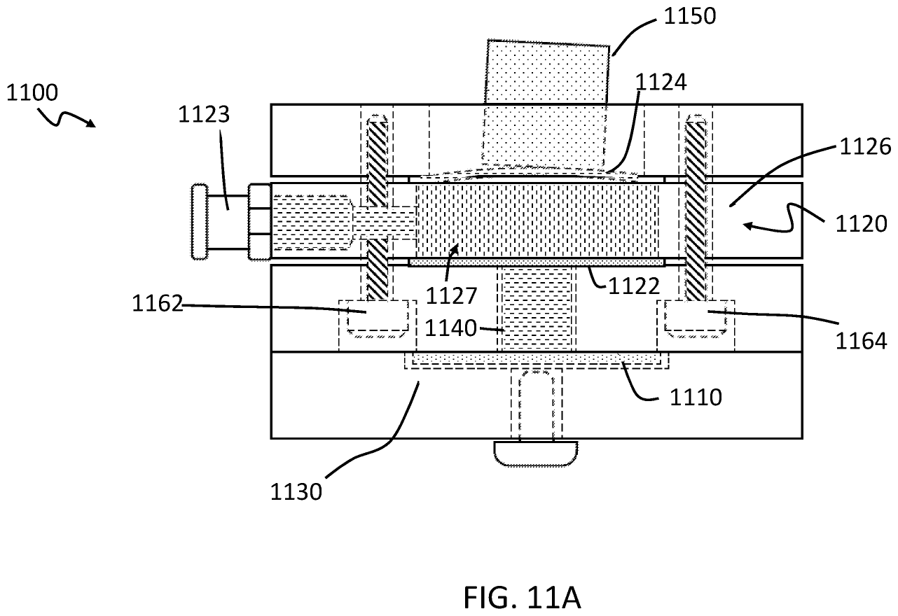

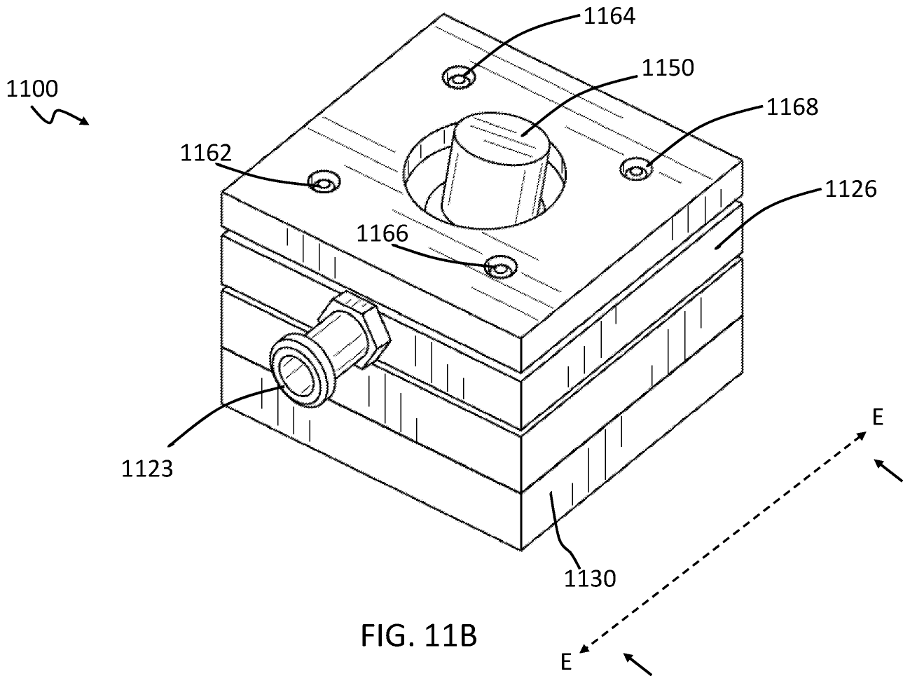

Referring again to FIGS. 2A and 2B, the haptic actuator assembly 200 includes a fluid reservoir 220, which encloses a cavity 227 for holding a substantially non-compressible fluid 228 or any other fluid. In an embodiment, the cavity 227 is enclosed by a housing of the fluid reservoir 220. The housing may be cylindrical in shape, and may include a shell 226, a first layer 222, and a second layer 224. In another embodiment, the housing may have a shape that is not cylindrical (e.g., a shape that is rectangular). In the embodiment of FIGS. 2A and 2B, the shell 226 may form a ring-shaped sidewall of the fluid reservoir 220, and may form a seal with both the first layer 222 and the second layer 224. For instance, the shell 226 may be attached to the first layer 222 and the second layer 224 with an adhesive that provides such a seal. The shell 226 may be formed from plastic, glass, metal, or any other material. In an embodiment, when the haptic actuator assembly 200 is incorporated into a haptic-enabled device (e.g., device 10), the fluid reservoir 220 may already be filled with a fluid, such as the substantially non-compressible fluid 228. In another embodiment, the fluid reservoir 220 may be empty of any non-compressible fluid (e.g., 228) when the haptic actuator assembly 200 is incorporated into the haptic-enabled device. In such an embodiment, the haptic actuator assembly 200 may have an inlet that allows more fluid to be pumped into the fluid reservoir 220 (an inlet is depicted in FIG. 11B). In an embodiment, when the fluid 228 is placed into the cavity 227, the fluid 228 may be in direct contact with respective inward-facing surfaces of the first layer 222, the second layer 224, and the shell 226.

As depicted in FIGS. 2A and 2B, the fluid reservoir 220 may have a first side 220a (e.g., bottom side) and a second side 220b (e.g., top side) opposite the first side. In an embodiment, the first layer 222 may be disposed on the first side 220a of the fluid reservoir 220, and the second layer 224 may be disposed on the second side 220b. In the embodiment of FIGS. 2A and 2B, the first layer 222 may further form an entirety of the first side 220a of the fluid reservoir 220, or substantially the entirety of the first side 220a, and the second layer 224 may form an entirety of the second side 220b of the fluid reservoir 220, or substantially the entirety of the second side 220b. In an embodiment, the first layer 222 and the second layer 224 may form part of an outer surface of the fluid reservoir 220.

In the embodiment of FIGS. 2A and 2B, each of the first layer 222 and the second layer 224 may be a circular layer, and the two layers may have substantially the same diameter, or more generally have the same area. In other embodiments, which are discussed below, the layers of a fluid reservoir may have other shapes, and may have different respective areas. For instance, in another embodiment, an area of the first layer 222 may be larger than an area of the second layer 224.

In an embodiment, the substantially non-compressible fluid 228 may be a liquid, such as water or oil. In an embodiment, the fluid 228 may have a density that is equal to or greater than 1 g/cm³, or equal to or greater than 3 g/cm³. In one example, when the fluid reservoir 220 is filled with the non-compressible fluid 228, the fluid 228 may have a pressure that is a range of 5 kPa to 40 kPa, wherein the pressure may depend on a stiffness of the first layer 222 and/or of the second layer 224. In some instances, a volume of the non-compressible fluid 228 placed in the fluid reservoir 220 may be equal to or greater than a volume of the cavity 227 (as measured when the cavity 227 was empty of the non-compressible fluid 228), wherein the cavity 227 may refer to a space enclosed by the housing of the fluid reservoir 220. In an alternative embodiment, the fluid reservoir may be filled with a fluid that is a gas. In an embodiment, the haptic actuator assembly 200 may have a mass that is in a range of 20 g to 100 g when there is no fluid in the fluid reservoir 220.

In an embodiment, when there is no fluid in the cavity 227, the second layer 224 may be suspended by the sidewall (formed by shell 226) over the cavity 227. In some cases, a weight of the second layer 224 may cause the second layer to have a concave shape that curves inward relative to the housing of the fluid reservoir 220, especially if the second layer 224 has a sufficiently low rigidity. In such cases, the second layer 224 may retain the concave shape until fluid is placed into the cavity 227 and a pressure of the fluid is sufficiently high. For instance, FIG. 2A depicts a situation in which the pressure of the fluid 228 is sufficiently high to push the second layer 224 outward and to have a convex shape, in which the second layer 224 curves outward relative to the housing of the fluid reservoir 220.

In an embodiment, the first layer 222 may be formed to be more rigid than the second layer 224. For instance, the first layer 222 may be a metal disc, or more generally a metal layer, that forms a metal diaphragm, while the second layer 224 may be an elastomer layer (e.g., a silicone layer). As an example, the first layer 222 may be an aluminum disc having a diameter of 25 mm and a thickness of 1 mm, and, when the fluid reservoir 220 is filled with a fluid having a mass of, e.g., 3 g, the first layer 222 may have a resonance frequency of 170 Hz for a lowest mode of resonance of the first layer 222. In another example, the first layer 222 may be a plastic layer, and the second layer 224 may be a silicone layer having lower rigidity than the plastic layer. In yet another example, the first layer 222 may be formed from a bistable material. In some cases, a Young's Modulus of the first layer 222 may have a Young's Modulus of 1 N/mm to 10 N/mm (e.g., 2.8 N/mm). In an embodiment, the lower rigidity of the second layer 224 may contribute to an ability of the second layer 224 to vibrate with a greater amount of displacement relative to the first layer 222. In an embodiment, the lower rigidity of the second layer 224 may contribute to the second layer 224 having a lower spring constant relative to the first layer 222. For instance, a spring constant K of the first layer 222 or of the second layer 224 may be related to the quantity

$$\frac{π E {h}^{3}}{( 1 - {μ}^{2} ) {r}^{2}} ,$$

wherein “E” refers to a Young's Modulus of a particular layer, “h” refers to a thickness of the layer, “μ” refers to Poisson's ratio of a material of the layer, and “r” refers to a radius of the layer if the layer is circular. In such an instance, if the second layer 224 has a lower Young's Modulus E relative to the first layer 222, the lower Young's Modulus may contribute to the second layer 224 having a lower spring constant K relative to the first layer 222.

In an embodiment, the first layer 222 may have a first resonance frequency (also referred to as natural frequency), and the second layer 224 may have a second resonance frequency lower than the first resonance frequency. In an embodiment, the resonance frequency of the first layer 222 or of the second layer 224 may be related to the quantity

$$\sqrt{\frac{K}{m}} ,$$

wherein “K” for a particular layer refers to a spring constant of the layer, and “m” refers to a mass of the layer. In some cases, the first layer 222 may have a higher spring constant relative to the second layer 224, as discussed above. The higher spring constant of the first layer 222 may contribute to the first layer 222 having a higher resonance frequency. In some instances, a mass of the second layer 224 may be higher than a mass of the first layer 222. In other instances, the mass of the second layer 224 may be lower than the mass of the first layer 222, but the second layer 224 may still nave lower ratio of

$$\frac{K}{m}$$

relative to the first layer 222, such that the second layer 224 still has a lower resonance frequency relative to the first layer 222.

In an embodiment, the resonance frequency of the first layer 222 may be the same as or substantially the same as a resonance frequency of the actuator 210. In an embodiment, the resonance frequency of the first layer 210 may be in a range of, e.g., 1 KHz to 20 KHz or 5 KHz to 10 KHz. In an embodiment, the resonance frequency of the second layer 224 is lower than the resonance frequency of the first layer 222, and lower than the resonance frequency of the actuator 210. For instance, the resonance frequency of the second layer 224 is in a range of 10 Hz to 500 Hz, or a range of 50 Hz to 200 Hz, or a range of 100 Hz to 300 Hz. In some cases, the resonance frequency of the second layer 224 is equal to or less than half of the resonance frequency of the first layer 222.

As stated above, the resonance frequency of the second layer 224 may be based on a pressure of the substantially non-compressible fluid 228. In one example, the second layer 224 may have a resonance frequency of, e.g., 113 Hz and vibrate with an acceleration of 1.16 Gₚₚ when the fluid 228 is at a first level of pressure, wherein the level of pressure of the fluid 228 may be based on, e.g., how much of the non-compressible fluid 228 was placed in the fluid reservoir 220. In a second example, the second layer 224 may have a resonance frequency of, e.g., 127 Hz and vibrate with an acceleration of 1.96 Gₚₚ when the fluid 228 is at a second level of pressure higher than the first level (e.g., when a greater volume of the fluid 228 was placed in the fluid reservoir 220 relative to the above example). Additionally, in a third example, the second layer 224 may further have a resonance frequency of, e.g., 180 Hz and vibrate with an acceleration of 4.36 Gₚₚ when the fluid 228 is at a third level of pressure higher than the second level. In these examples, the haptic actuator assembly 200 may amplify an amount of acceleration that is generated by the actuator 210 by a factor of, e.g., two to four times.

As stated above, the first resonance frequency and the second resonance frequency may both refer to a temporal frequency. For instance, if a vibration of the first layer 222 or the second layer 224 exhibits a standing wave having the respective resonance frequency of the first layer 222 or the second layer 224, the resonance frequency (or, more generally, a frequency of the vibration) may refer to how quickly an antinode of the standing wave oscillates around an equilibrium position (e.g., how many cycles per second). As a specific example, a vibration of the first layer 222 or of the second layer 224 may in one scenario have a temporal component, such as (A₁ cos λₘₙct+A₂ sin λₘₙct), and a spatial component, such as Jₘ(λₘₙτ)(A₃ cosmθ+A₄ sinmθ). In this example, the spatial component and the temporal component may be added to determine, e.g., a displacement of each position r, 0 on the layer (in cylindrical coordinates) as a function of time t. Further, the parameters m, n in this example may refer to a mode of resonance, the term Jₘ may refer to a m-order Bessel function, while λₘₙ may be related to a root of the m-order Bessel function, c may refer to a speed of transverse vibration in the layer, and the parameters A₁, A₂, A₃, A₄ may be constants. In this example, the resonance frequency or frequency of the vibration may refer to a frequency of the temporal component of the standing wave (e.g., λₘₙc). In an embodiment, the first layer 222 may vibrate at a lower mode of resonance relative to the second layer 224. For instance, the first layer 222 may vibrate at its lowest mode of resonance (e.g., m=0, n=1), while the second layer 224 may vibrate at a higher mode of resonance (e.g., m=0, n=2).

In an embodiment, the second layer 224 may be thicker than the first layer 222. For instance, the first layer 222 may have a thickness that is in a range of 0.01 mm to 0.06 mm (e.g., 0.05 mm) or a range of 0.02 mm to 0.08 mm, and the second layer 224 may have a thickness that is in a range of 0.1 mm to 0.5 mm (e.g., 0.3 mm). In an embodiment, the thickness of the second layer 224 may be at least five times or at least ten times greater than the thickness of the first layer 222. In some cases, while the second layer 224 has greater thickness than the first layer 222, it may have other parameter values (e.g., Young's Modulus) that are sufficiently smaller relative to the first layer 222 so as to still have a lower spring constant relative to the first layer.

As stated above, the actuator 210 may be configured to generate an initial vibration having a first amount of displacement or acceleration, and may be mechanically coupled to the first layer 222 of the fluid reservoir 220. In the embodiment of FIGS. 2A and 2B, the mechanical coupling can be accomplished via direct contact between the actuator 210 and the first layer 222. For instance, the actuator 210 may be directly attached to the first layer 222 via an adhesive. As also stated above, the first layer 222 may have a first resonance frequency, and the second layer 224 may have a second resonance frequency lower than the first resonance frequency. The mechanical coupling may transfer a force of the initial vibration from the actuator 210 to the first layer 222 to cause a first vibration in which the first layer 222 vibrates at the first resonance frequency with a first amount of displacement or acceleration of the first layer 222. For instance, the first amount of displacement may be in a range of 10 μm to 350 μm or, more generally, may be less than 350 μm. Further, a force of the first vibration (also referred to as a force provided by the first vibration) may be the same as a force of the initial vibration (also referred to as a force provided by the initial vibration), or may be different than the force of the initial vibration.

In an embodiment in which there is direct contact between the first layer 222 and the actuator 210, such as that illustrated in FIGS. 2A and 2B, the actuator 210 and the first layer 222 may in some instances vibrate together in complete unison. In such instances, the initial vibration of the actuator 210 may be considered to be the same as the first vibration of the first layer 222. In another embodiment in which an actuator and a first layer are separated by an intermediate object, such as a rod illustrated in FIGS. 4A through 7 (which is discussed below in more detail), the initial vibration of the actuator may be considered to be a separate vibration from the first vibration of the first layer.

In an embodiment, the fluid reservoir 220 may be configured to transfer forces from the actuator 210 to the second layer 224 via the first layer 222 and the substantially non-compressible fluid 228. More specifically, when the fluid reservoir 220 is filled with the substantially non-compressible fluid 228, the fluid reservoir 220 may be configured to transfer a force of a first vibration (in which the first layer 222 vibrates) from the first layer 222 to the second layer 224 to cause a second vibration in which the second layer 224 vibrates. During the second vibration, the second layer 224 may vibrate with a second amount of displacement or acceleration that is higher than the first amount of displacement or acceleration experienced by the first layer 222 during the first vibration. In some cases, the second amount of displacement is more than 1 mm. For instance, the second amount of displacement may be in a range of 1.5 mm to 10 mm, or 2 mm to 20 mm. In some cases, the second amount of acceleration associated with the second amount of displacement may be in a range of 1 Gₚₚ to 5 Gₚₚ, or a range of 2 Gₚₚ to 10 Gₚₚ. Because the second vibration of the second layer 224 results in higher displacement or acceleration of the second layer than a displacement or acceleration of the first layer 222 provided by the first vibration, the second vibration of the second layer 224 may generate more force relative to the first vibration of the first layer 222, and relative to the initial vibration of the actuator 210. As a result, the second vibration in which the second layer 224 vibrates may be easier to perceive relative to the initial vibration generated by the actuator 210 and/or relative to the first vibration of the first layer 222. In an embodiment, the second vibration of the second layer 224 may be an output vibration of the haptic actuator assembly 200, and may be used to generate a haptic effect.

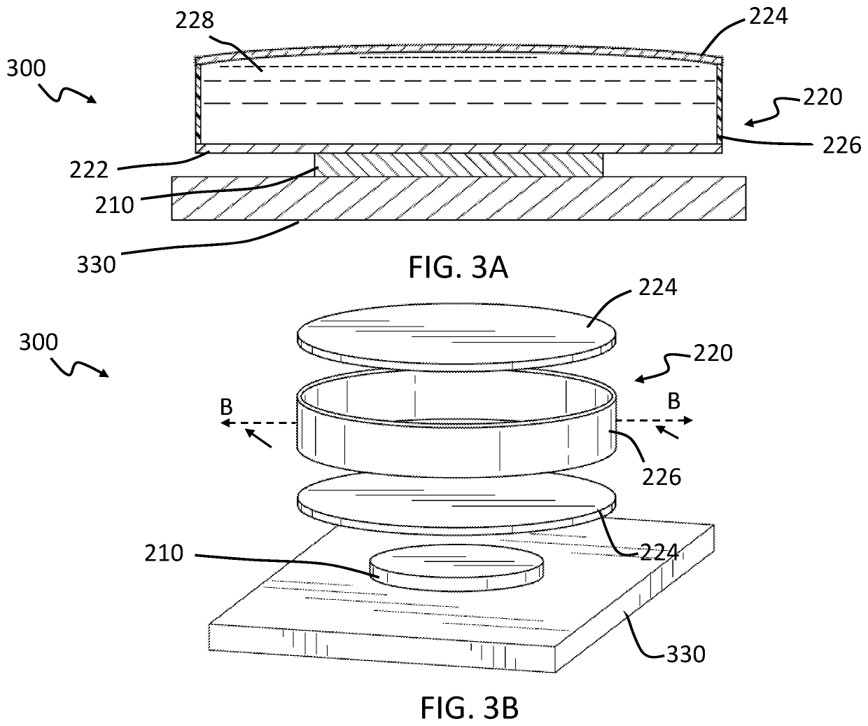

In an embodiment, the haptic actuator 210 may be disposed between the fluid reservoir 220 and a mounting structure, and the two structures may provide a pre-load for the actuator 210. For instance, FIGS. 3A and 3B illustrate a haptic actuator assembly 300 that is an embodiment of the haptic actuator assembly 200. FIG. 3A provides a sectional view of the haptic actuator assembly 300 taken along line B-B of FIG. 3B, while FIG. 3B provides an exploded view of the haptic actuator assembly 300. The haptic actuator assembly 300 may be an embodiment of the haptic actuator assembly 100/200, and may include an actuator 210 and a fluid reservoir 220, as described with respect to FIGS. 2A and 2B. As depicted in FIGS. 3A and 3B, the haptic actuator assembly 300 further includes a mounting structure 330. The mounting structure 330 may be, e.g., a plastic block, glass block, or metal block on which the actuator 220 is directly disposed. In an embodiment, each of the fluid reservoir 220 and the mounting block 330 may be fixedly attached to, e.g., both press against, the actuator 210, so as to resist any expansion by the actuator 210 that would push the fluid reservoir and the mounting block further apart. This resistance may provide a pre-load for the actuator 210, which may enhance an amount of force that the actuator 210 can generate.

As stated above, an actuator (e.g., 110) may be mechanically coupled to a first layer (e.g., 122) of a fluid reservoir (e.g., 120) via an intermediate object, such as a rod. FIGS. 4A and 4B depict a haptic actuator assembly 400 that is an embodiment of the haptic actuator assembly 100 of FIG. 1, and that includes a rod 440, an actuator 410, and a fluid reservoir 420. FIG. 4A illustrates a sectional view of the haptic actuator assembly 400 taken along line C-C of FIG. 4B, and FIG. 4B depicts an exploded view of the haptic actuator assembly 400. The actuator 410 may be the same as, or substantially similar to, the actuator 210 of FIGS. 2A and 2B. The fluid reservoir 420 includes a first layer 422 and a second layer 424, and may be configured to hold a substantially non-compressible fluid 428, and may be the same as or substantially similar to the fluid reservoir 220.

In an embodiment, the rod 440 may act as a plunger that mechanically couples the actuator 410 to the first layer 422 of the fluid reservoir 420. In an embodiment, the first layer 422 may be a metallic diaphragm, and the rod 440 may be substantially rigid, and may be configured to transfer a force of an initial vibration generated by the actuator 410 to the first layer 422 (e.g., to a center of the first layer). The transferred force may cause an elastic deformation of the first layer 422, and more specifically may cause a first vibration in which the first layer 422 vibrates. In some cases, the elastic deformation of the first layer 422 may exert pressure on the substantially non-compressible fluid 428 and generate a pressure pulse that travels through the fluid 428 of the fluid reservoir 420. The pressure pulse may transfer a force of the first vibration from the first layer 422 to the second layer 424 of the fluid reservoir 420. The second layer 424 may be, e.g., an elastomer layer that vibrates as a result of the transfer of the force from the first layer 422 to the second layer 424.

In an embodiment, the rod 440 may have a cylindrical shape, a rectangular shape, or any other shape. In an embodiment, the rod 440 may have a smaller cross-sectional area than that of the first layer 422 and/or that of the actuator 410. For instance, if the rod 440 is a cylinder, the cross-sectional area of the rod may refer to an area of a circle that forms a cross-section of the rod 440. In one example, that cross-section of the rod 440 may have a radius that is at least two to ten times smaller than a radius of the first layer 422. The rod 440 may act as a plunger that presses against a center or other portion of the first layer 422. This arrangement may allow a force generated by an initial vibration of the actuator 410 to be concentrated at the center, or other portion, of the first layer 422. The first layer 422 may be formed from a material (e.g., metal) that resists being punctured or otherwise damaged by the concentrated force. Concentrating the force at only a portion of the first layer 422 may enhance an amount of displacement by which the first layer 422 vibrates (e.g., relative to an amount of displacement by which the first layer 222 vibrates in FIGS. 2A and 2B). The increased displacement of the first vibration of the first layer 422 may lead to an increased displacement of the second vibration of the second layer 424, which may in turn enhance an amount of force generated by the second vibration, and more generally enhance an amount of force generated by a vibration output by the haptic actuator assembly 400.

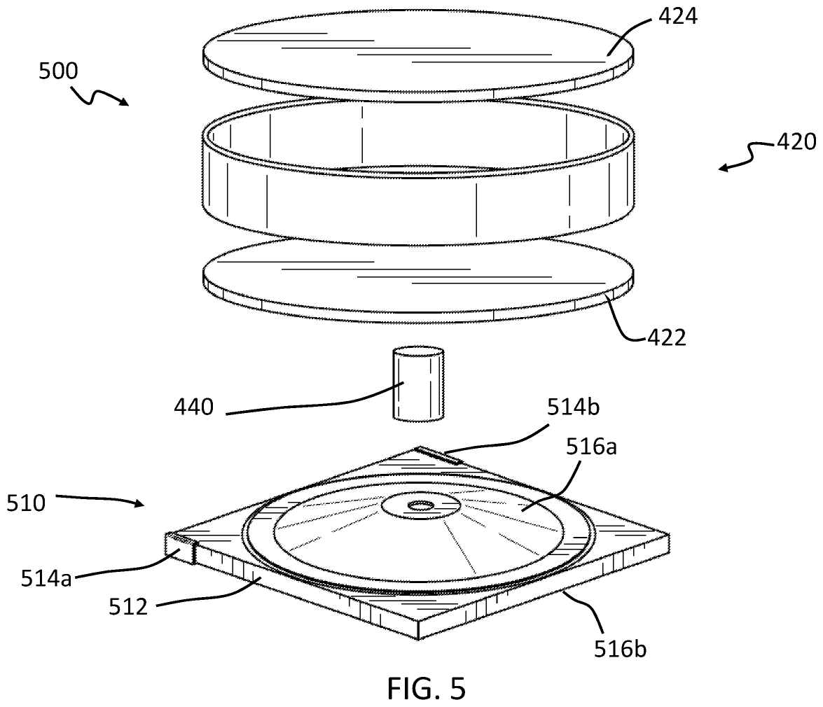

As stated above, an actuator (e.g., 110/210/410) of embodiments described in accordance herewith may be a piezoelectric actuator, such as a TDK® PowerHap™ actuator. FIG. 5 depicts an exploded view of a haptic actuator assembly 500 that includes an actuator 510 that is a TDK® PowerHap™ actuator. More specifically, the haptic actuator assembly 500 is an embodiment of the haptic actuator assembly 400, and includes the fluid reservoir 420, the rod 440, and the actuator 510, which may be an embodiment of the actuator 410.

In an embodiment, the actuator 510 may include a layer 512 of piezoelectric material (e.g., PZT) configured to generate strain. In an embodiment, the layer 512 may have a length that is in a range of 9 mm to 25 mm, a width that is in a range of 9 mm to 25 mm, and a thickness that is in a range of 0.3 mm to 2 mm. The actuator 510 may further include electrodes 514a, 514b that are in contact with the piezoelectric material of the layer 512. When a voltage difference is created between the electrodes 514a, 514b, the piezoelectric material may be configured to output strain. In an embodiment, the actuator 510 may further include a pair of displacement conversion devices 516a, 516b (not shown) that are configured to convert strain of the piezoelectric material, which may be along an axis parallel to the layer 512, to displacement along another axis perpendicular to the layer 512. As depicted in FIG. 5, the displacement conversion device 516a may include a disc that forms a truncated cone (also referred to as a cymbal), and may be disposed on a first side of the layer 512 of piezoelectric material. The displacement conversion device 516b (not shown) may, in an embodiment, have an identical structure as the displacement conversion device 516a, and may be disposed on a second and opposite side of the layer 512. The displacement conversion devices are discussed in more detail in U.S. patent application Ser. No. 16/010,169, entitled “Haptic Actuator Assembly Having a Magnetic Pre-Load Device,” the entire content of which is incorporated by reference herein. In an embodiment, the rod 440 may be in contact or otherwise disposed on the displacement conversion device 516a. In an embodiment, the displacement conversion devices 516a, 516b may form at least part of a housing of the actuator 510.

In an embodiment, when a driving signal is applied to the electrodes 514a, 514b, the layer 512 of piezoelectric material may vibrate along a first axis parallel to the layer 512. The displacement conversion devices 516a, 516b may be configured, in response to the vibration of the piezoelectric material along the first axis, to vibrate along a second axis perpendicular to the first axis. The vibration of the displacement conversion device 516a, 516b may be, e.g., an initial vibration generated by the actuator 510, and may generate a force that is transferred by the rod 440 to the first layer 422 of the fluid reservoir 420 to cause a first vibration in which the first layer 422 vibrates. A force of the first vibration may be transferred by a fluid in the fluid reservoir 420 from the first layer 422 to a second layer 422 to cause a second vibration in which the second layer 424 vibrates.

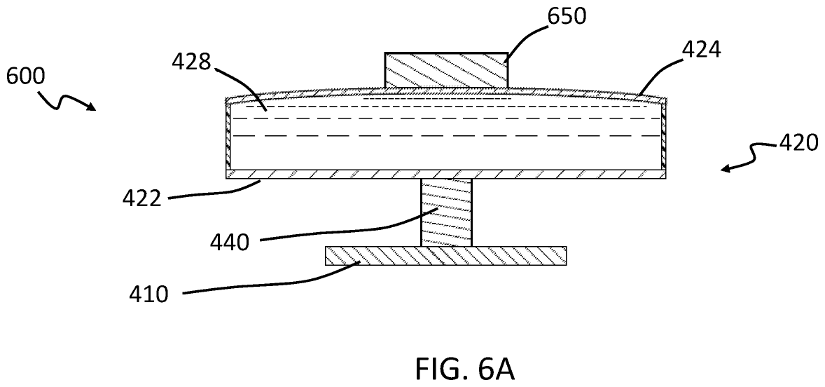

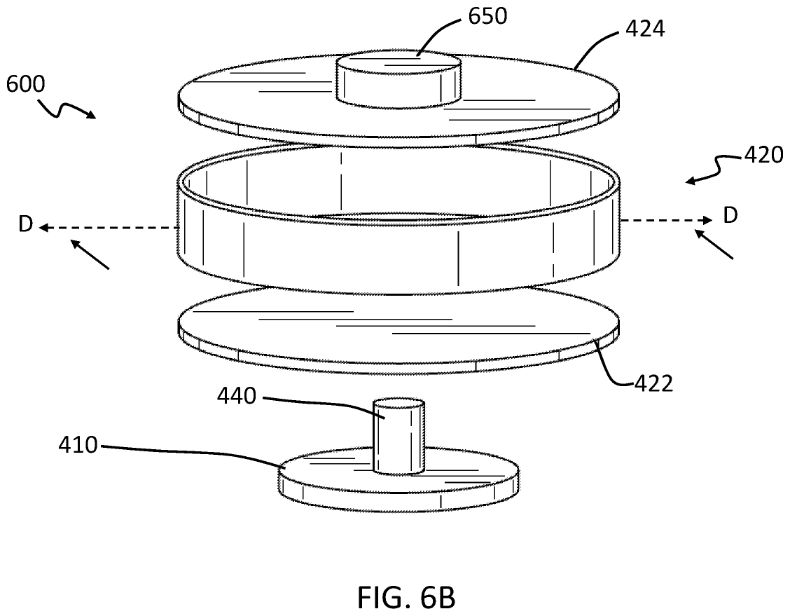

FIGS. 6A and 6B illustrate a haptic actuator assembly 600 that attaches an object to a second layer 424 of a fluid reservoir 420, so as to increase an effective mass of the second layer. FIG. 6A depicts a sectional view of the haptic actuator assembly 600 taken along line D-D of FIG. 6B, while FIG. 6B illustrates an exploded view of the haptic actuator assembly 600. More specifically, the haptic actuator assembly 600 is an embodiment of the haptic actuator assembly 400, and may include an actuator 410, a fluid reservoir 420, and a rod 440 that mechanically couples the actuator 410 to the fluid reservoir 420.

The haptic actuator assembly 600 further includes an object 650 attached to the second layer 424. As stated above, a resonance frequency of a layer may be related to the quantity

$$\sqrt{\frac{K}{m}} .$$

This quantity indicates that the resonance frequency of a particular layer may be lowered by decreasing its spring constant, and/or by increasing a mass of or attached to the layer. More specifically, the resonance frequency of the second layer 424 in FIGS. 6A and 6B may be related

$$\sqrt{\frac{{K}_{1}}{{m}_{1} + {m}_{2}}} ,$$

to the quantity wherein “K₁” is a spring constant of the second layer 424, “m₁” is a mass of the second layer 424, “m₂” is a mass of the object 650, and “m₁+m₂” is an effective mass of the second layer 424. Thus, the mass from the object 650 may increase an effective mass of the second layer 424, and may decrease a resonance frequency of the second layer 424 relative to an implementation in which the object 650 is not present. In an embodiment, the object 650 may be directly attached to the second layer 424 (e.g., via an adhesive) and may be able to vibrate together (e.g., in unison) with the second layer 424. In an embodiment, the object 650 may be a block (e.g., a plastic block or wooden block) having a mass that is, e.g., in a range of 1 g to 10 g.

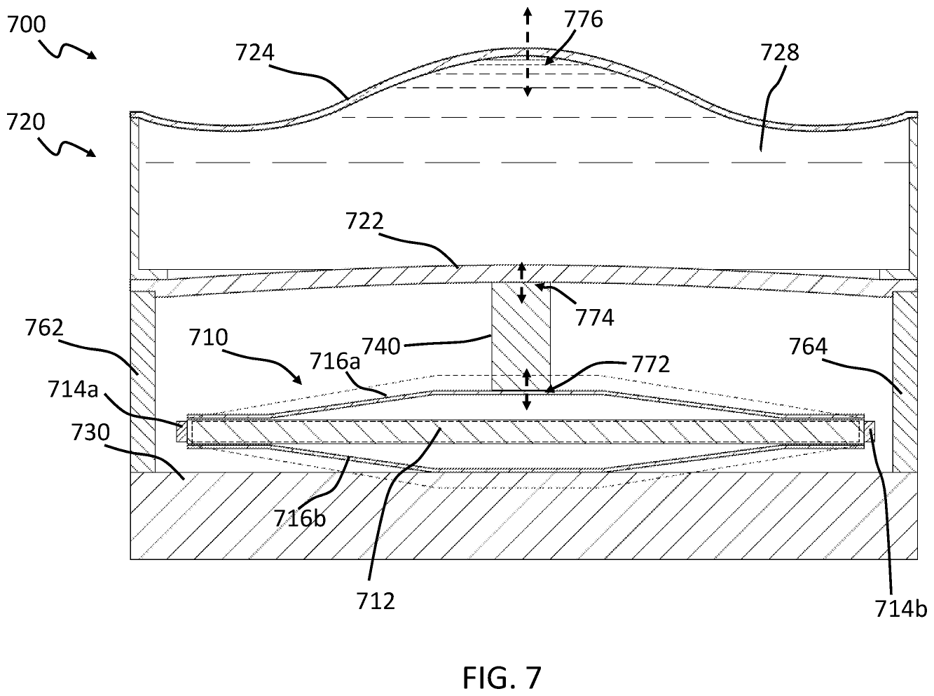

FIG. 7 depicts displacement provided by a vibration output by a haptic actuator assembly. More specifically, FIG. 7 illustrates a haptic actuator assembly 700 that may be an embodiment of the haptic actuator assembly 100/400/500. The haptic actuator assembly 700 may include an actuator 710, a fluid reservoir 720, a rod 740, and a mounting structure 730. The actuator 710 may disposed between the fluid reservoir 720 and the mounting structure 730, and more specifically between the rod 740 and the mounting structure 730. In an embodiment, the fluid reservoir 720 may include a first layer 722 and a second layer 724, which may be the same as or substantially similar to, e.g., the first layer 122/222/422 and the second layer 124/224/424, respectively. Further, the rod 740 may mechanically couple the actuator 710 to the first layer 722 of the fluid reservoir 720. In some cases, the mounting structure 730 may be directly attached to the fluid reservoir 720 via one or more fastening components 762, 764 (e.g., a pair of screws).

As illustrated in FIG. 7, the actuator 710 may be configured to generate an initial vibration 772 (represented by up and down arrows) that provides a first amount of displacement or acceleration. The actuator 710 may be, e.g., the same as or substantially similar to the actuator 110/210/410/510. For instance, like actuator 510, the actuator 710 may have at least two electrodes 714a, 714b and a layer 712 of actuatable material that is configured to exhibit strain when a voltage difference is generated between the at least two electrodes 714a, 714b. The actuator 710 may further include a first displacement conversion device 716a and a second displacement conversion device 716b, which may be the same as or substantially similar to the displacement conversion devices 516a, 516b. When the layer 712 undergoes strain along an axis parallel to the layer 712, the strain may cause movement of the displacement conversion devices 716a, 716b along an axis perpendicular to the layer 712. The movement of the displacement conversion devices 716a, 716b may generate the initial vibration 772. In some instances, the vibration 772 may have a frequency that is equal to a resonance frequency of the actuator 710.

As stated above, the actuator 710 may be mechanically coupled to the first layer 722 of the fluid reservoir 720. The mechanical coupling may be via the rod 740 and may be configured to transfer a force of the initial vibration 772 to the first layer 722 to cause a first vibration 774 in which the first layer 722 vibrates. For instance, FIG. 7 depicts the resulting first vibration 774 (represented by up and down arrows) of the first layer 722. In some instances, the first vibration 774 may have a frequency and/or provide a displacement that is the same as a frequency of and/or a displacement provided by the initial vibration 772. In other instances, the frequency of and/or the displacement provided by the first vibration 774 may be different than the frequency of and/or the displacement provided by the initial vibration 772.

In an embodiment, the first vibration 774 may have the form of a standing wave of the first layer 722, wherein the standing wave is oscillating at a resonance frequency of the first layer 722. In some cases, as illustrated in FIG. 7, the standing wave of the first vibration 774 may have a lowest mode of resonance, in which the standing wave has only a single antinode. For instance, if the vibration 774 is expressed by the quantity uₘₙ=(A₁ cos λₘₙct+A₂ sin λₘₙct)Jₘ(λₘₙτ) (A₃ cos mθ+A₄ sin mθ), wherein uₘₙ refers to a displacement for mode m, n at a location λ, θ on the first layer 722 (in cylindrical coordinates), and wherein the other parameters are discussed above, the lowest mode of resonance may correspond to m=0 and n=1. In one example, the first layer 722 may be, e.g., an aluminum disc having a diameter of 25 mm and a thickness of 1 mm, and the fluid reservoir 720 may have a substantially non-compressible fluid 728 with a mass of, e.g., 3 g. In this example, the lowest mode of resonance for the first layer 722 may have a resonance frequency of 170 Hz, and a displacement of, e.g., 0.04 mm when there is a 1 N load.

In an embodiment, the fluid reservoir 720 may provide fluid coupling between the first layer 722 and the second layer 724. More specifically, when the fluid reservoir 720 is filled with a substantially non-compressible fluid 728, the fluid reservoir 720 may be configured to transfer a force of the first vibration 774 from the first layer 722 to the second layer 724 to cause a second vibration 776 in which the second layer 724 vibrates. FIG. 7 illustrates the resulting second vibration 776 (represented by up and down arrows) of the second layer 724. In an embodiment, the second vibration 776 may provide a higher amount of displacement or acceleration than an amount of displacement or acceleration provided by the initial vibration 772 and/or of the first vibration 774. In some cases, the second vibration 776 may have a frequency equal to a resonance frequency of the second layer 724. Further, as depicted in FIG. 7, the second vibration 776 may have a higher mode of resonance relative to the first vibration 774, and thus may have multiple antinodes. For instance, in an example in the displacement provided by the second vibration 776 is described by the above equation for uₘₙ, an example of the higher mode of resonance for the second vibration 776 of the second layer 724 may be, e.g., mode m=0, n=2.

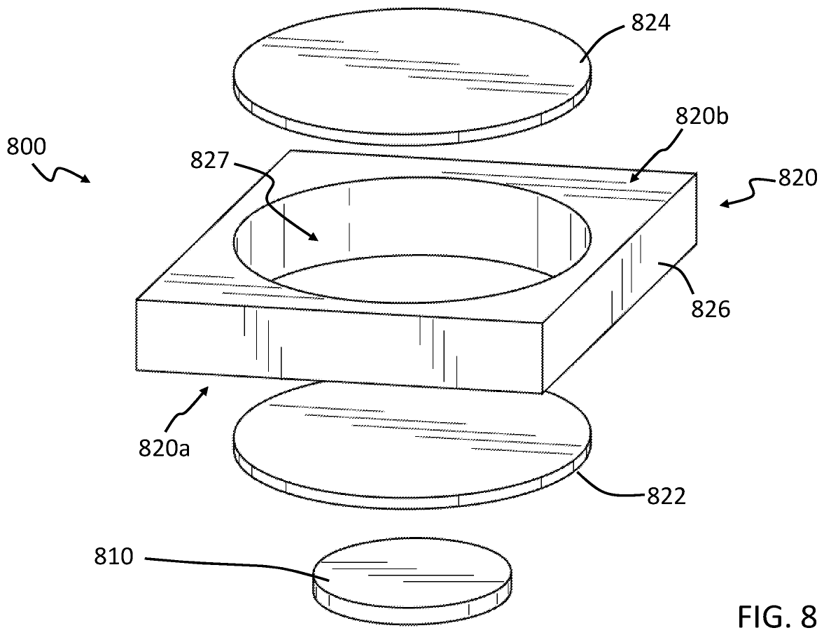

FIG. 8 illustrates a haptic actuator assembly 800 in which a housing of its fluid reservoir has a rectangular shape. More specifically, FIG. 8 provides an exploded view of the haptic actuator assembly 800, which may be an embodiment of the haptic actuator assembly 100, and which has an actuator 810 and a fluid reservoir 820. In an embodiment, the fluid reservoir 820 has a housing formed by a first layer 822, a second layer 824, and a shell 826. The first layer 822 and the second layer 824 may be the same as or substantially similar to the first layer 222/422/722 and the second layer 224/424/724, respectively. In an embodiment, the shell 826 may have an exterior profile that forms a rectangular box, and may enclose a cavity 827 for holding a fluid.

As depicted in FIG. 8, the fluid reservoir 820 may have a first side 820a and a second side 820b. The first layer 822 (e.g., metal diaphragm) may form only a part of the first side 820a, and the second layer 824 (e.g., elastomer layer) may form only a part of the second side 820b. Both the first layer 822 and the second layer 824 may form a seal with the shell 826. The fluid reservoir 820 of FIG. 8 may be combined with or incorporated into the features of other embodiments, such as any of the embodiments of FIGS. 2A through 7.

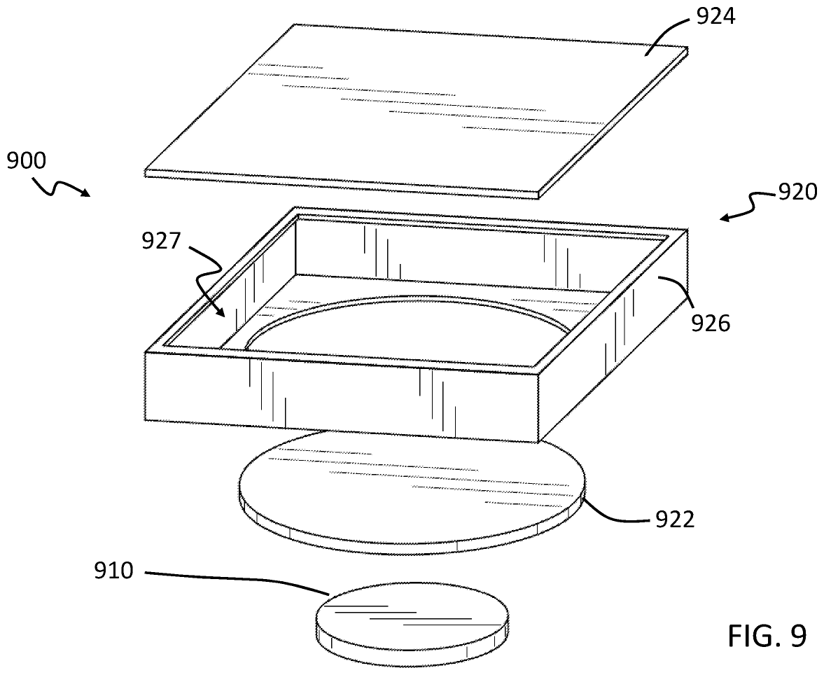

FIG. 9 depicts a haptic actuator assembly 900 in which a second layer 924 of the fluid reservoir 920 has a rectangular shape. More specifically, FIG. 9 provides an exploded view of the haptic actuator assembly 900, which may be an embodiment of the haptic actuator assembly 100, and which includes an actuator 910 and a fluid reservoir 920. In an embodiment, the actuator 910 may be the same or substantially the same as the actuator 210/410/510/710. The fluid reservoir 920 may have a housing that is formed by a first layer 922 (e.g., metal diaphragm), a second layer 924 (e.g., elastomer layer), and a shell 926. The shell 926, or more generally the housing of the reservoir 920, may enclose a cavity 927 for holding a fluid. As depicted in FIG. 9, the second layer 924 may have a rectangular shape, and may have a larger area than the first layer 922. In another embodiment, the first layer 922 may have a larger area than the second layer 924. The fluid reservoir 920 of FIG. 9 may be combined with or incorporated into the features of other embodiments, such as any of the embodiments of FIGS. 2A through 7.

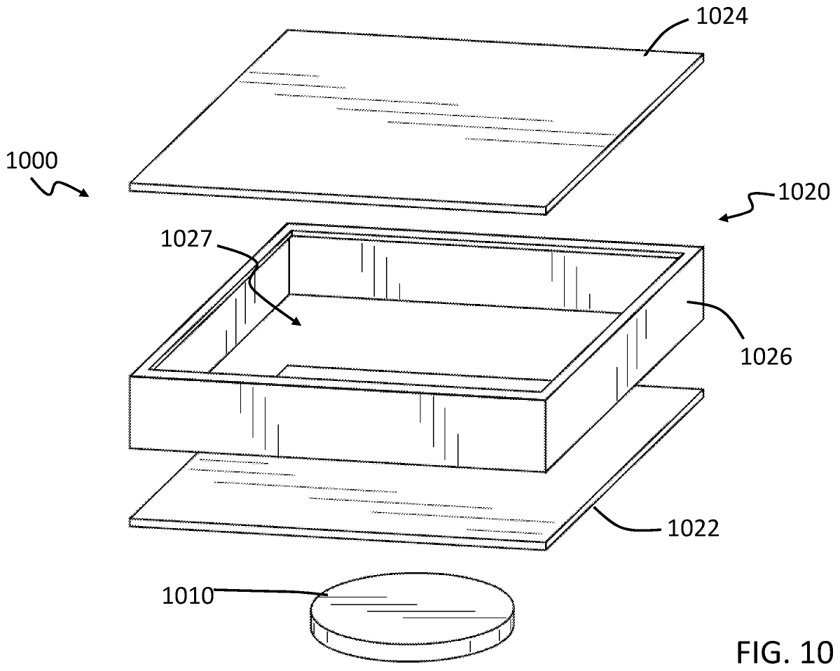

FIG. 10 provides an exploded view of a haptic actuator assembly 1000 having two rectangular layers. More specifically, the haptic actuator assembly 1000 is an embodiment of the haptic actuator assembly 100, and may include an actuator 1010 and a fluid reservoir 1020. The fluid reservoir 1020 may have a housing formed by a first layer 1022 (e.g., metal diaphragm), a second layer 1024 (e.g., elastomer layer), and a shell 1026. The housing may enclose a cavity 1027 for holding a fluid. As illustrated in FIG. 10, both the first layer 1022 and the second layer 1024 may be rectangular layers. The fluid reservoir 1020 of FIG. 10 may be combined with or incorporated into the features of other embodiments, such as any of the embodiments of FIGS. 2A through 7.

FIGS. 11A and 11B depict a haptic actuator assembly 1100 that is an embodiment of the haptic actuator assembly 100, and that includes an inlet for fluid to be pumped into the haptic actuator assembly 1100. FIG. 11A provides a side view of the haptic actuator assembly taken along line E-E of FIG. 11B, while FIG. 11B provides a perspective view. More specifically, as depicted in FIG. 11A, the haptic actuator assembly 1100 includes an actuator 1110, a rod 1140, a fluid reservoir 1120, and an object 1150 attached to the fluid reservoir 1120. The actuator 1110, the rod 1140, and the object 1150 may be the same or substantially similar to, e.g., the actuator 110/210/410/510/710, the rod 440/740, and the object 650, respectively. Further, the actuator 1110 may be disposed on a mounting structure 1130, such as a glass block. In an embodiment, the fluid reservoir 1120 and the actuator 1110 may be attached to each other via fastening components 1162, 1164, 1166, and 1168 (e.g., screws).

In an embodiment, the fluid reservoir 1120 may include a first layer 1122 and a second layer 1124, and a shell 1126 formed from a glass or plastic block. The shell 1126, the first layer 1122, and the second layer 1124 may enclose a cavity 1127 for holding a fluid. As depicted in FIGS. 11A and 11B, the fluid reservoir 1120 may further include an inlet 1123, which may provide a passage that allows a fluid to flow into or out of the cavity 1127. In an embodiment, the haptic-enabled device 10 of FIG. 1B may include a pump, and the inlet 1123 of the haptic actuator assembly 1100 of FIG. 11B may be attached to the pump.

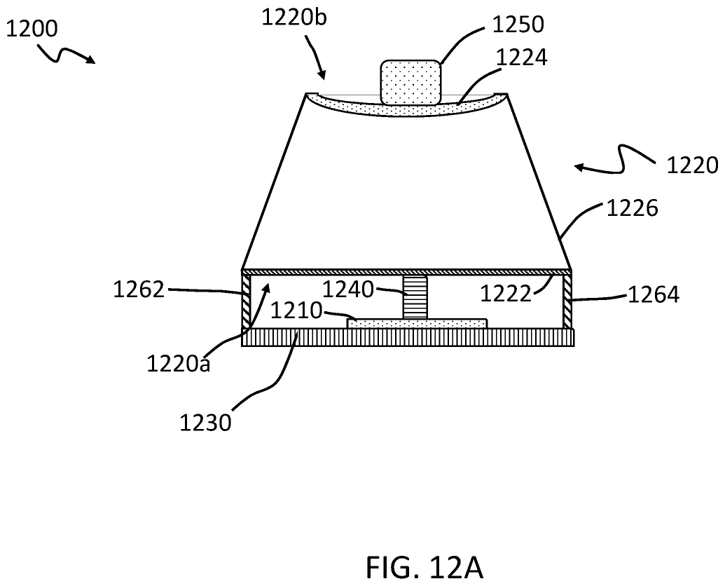

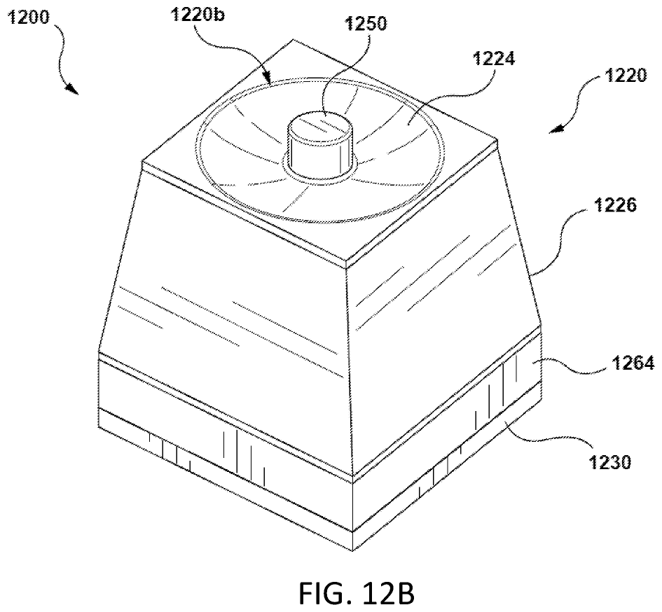

FIGS. 12A and 12B depict a haptic actuator assembly 1200 having a fluid reservoir 1220 that tapers in size. More specifically, FIGS. 12A and 12B illustrate a partial sectional view and a perspective view, respectively, of the haptic actuator assembly 1200, which may be an embodiment of the haptic actuator assembly 100, and which includes an actuator 1210, the fluid reservoir 1220, a mounting structure 1230, a rod 1240, and an object 1250 attached to the fluid reservoir 1220. The actuator 1210, the mounting structure 1230, the rod 1240, and the object 1250 may be the same as or substantially similar to the actuator 110/210/410/510/710, the mounting structure 330, the rod 440, and the object 650, respectively. In an embodiment, one or more fastening components or side walls 1262, 1264 may attach the mounting structure 1230 to the fluid reservoir 1220.

In an embodiment, the fluid reservoir 1220 may have a first layer 1222 (e.g., metal diaphragm), a second layer 1224 (e.g., elastomer layer), and a shell 1226, which may together form a housing of the fluid reservoir 1220. In an embodiment, the housing may be shaped as a truncated cone that decreases in diameter in a direction from the first layer 1222 to the second layer 1224 or a truncated pyramid that decreases in width in a direction from the first layer 1222 to the second layer 1224, as depicted in FIG. 12B. In other words, the fluid reservoir 1220 may have a first side 1220a that has a larger area than a second side 1220b of the fluid reservoir 1220, wherein the first layer 1222 may completely or partially form the first side 1220a, and the second layer 1224 may completely or partially form the second side 1220b. In some implementations, the larger area of the first side 1220a of the fluid reservoir 1220 may contribute to amplifying an amount of displacement provided by an initial vibration of the actuator 1210.

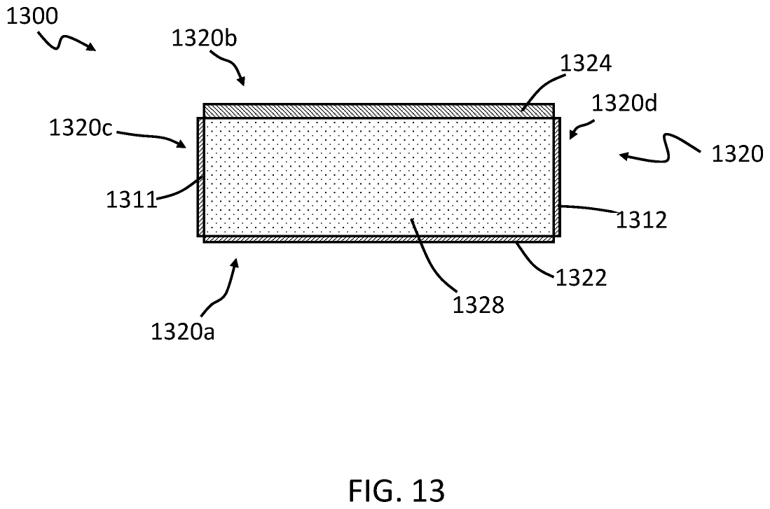

FIG. 13 depicts a haptic actuator assembly 1300 having an actuator that directly contacts fluid in a fluid reservoir. More specifically, the haptic actuator assembly 1300 may include a fluid reservoir 1320 having a housing that is formed by at least a first actuator 1311, a second actuator 1312, a first layer 1322, and a second layer 1324. In an embodiment, the fluid reservoir 1320 may be rectangular in shape, and may have a first side 1320a and a second side 1320b that are opposite each other, and may further have a third side 1320c and a fourth side 1320d that are opposite each other. The first layer 1322, the second layer 1324, and the first and second actuators 1311, 1312 may form a housing of the fluid reservoir 1320. More specifically, the first layer 1322 (e.g., a glass layer) may be disposed on the first side 1320a of the fluid reservoir 1320a, the second layer 1324 (e.g., silicone layer) may be disposed on the second side 1320b, the first actuator 1311 may be disposed on the third side 1320c, and the second actuator 1312 may be disposed on the fourth side 1320d.

In an embodiment, each actuator of the first and second actuators 1311, 1312 may be a piezoelectric actuator or EAP actuator, and may be in direct contact with a fluid 1328 in the fluid reservoir 1320. When one or both of the first actuator 1311 or the second actuator 1312 vibrates, the fluid 1328 may transfer a force from the vibration of the first actuator 1311 or second actuator 1312 to the second layer 1324, to cause the second layer 1324 to vibrate.

Additional Discussion of Various Embodiments:

Embodiment 1 of an aspect of the present disclosure relates to a haptic actuator assembly, comprising a fluid reservoir and an actuator. The fluid reservoir is configured to hold a substantially non-compressible fluid, the fluid reservoir having a first layer disposed on a first side of the fluid reservoir, and having a second layer that is less rigid than the first layer and disposed on a second side of the fluid reservoir that is opposite of the first side, wherein the first layer has a first resonance frequency and the second layer has a second resonance frequency lower than the first resonance frequency. The actuator is mechanically coupled to the first layer of the fluid reservoir, the actuator being configured to cause a first vibration in which the first layer vibrates at the first resonance frequency and provides a first amount of displacement or acceleration of the first layer. The fluid reservoir, when filled with the substantially non-compressible fluid, is configured to transfer a force of the first vibration from the first layer to the second layer to cause a second vibration in which the second layer vibrates at the second resonance frequency and provides a second amount of displacement or acceleration of the second layer that is higher than the first amount of displacement or acceleration of the first layer.

Embodiment 2 includes the haptic actuator assembly of embodiment 1. In the embodiment, the first layer of the fluid reservoir is a circular metal layer that forms a metallic diaphragm, and the second layer of the fluid reservoir is an elastomer layer.

Embodiment 3 includes the haptic actuator assembly of embodiment 2. In the embodiment, the elastomer layer is a silicone layer.

Embodiment 4 includes the haptic actuator assembly of embodiment 2 or 3. In the embodiment, the metallic diaphragm is mechanically coupled to the actuator by a rod disposed therebetween, wherein the actuator is configured to generate an initial vibration in which the actuator vibrates, wherein the rod is substantially rigid and is configured to transfer a force of the initial vibration to a center of the metallic diaphragm to cause an elastic deformation thereof, and wherein the elastic deformation of the center of the metallic diaphragm causes the first vibration, and the first vibration is configured to generate a pressure pulse that travels through the substantially non-compressible fluid to cause the second vibration.

Embodiment 5 includes he haptic actuator assembly of any one of embodiments 1-4. In the embodiment, the first amount of displacement of the first layer provided by the first vibration is less than 350 μm, and the second amount of displacement of the second layer provided by the second vibration is more than 1 mm.

Embodiment 6 includes the haptic actuator assembly of embodiment 4 or 5. In the embodiment, the initial vibration has a frequency that is in a range of 5 KHz to 10 KHz, and wherein the second resonance frequency at which the second layer of the fluid reservoir vibrates during the second vibration is in a range of 100 Hz to 300 Hz.

Embodiment 7 includes the haptic actuator assembly of any one of embodiments 4-6. In the embodiment, when the elastic deformation is generated by the metallic diaphragm vibrating at a lowest mode of resonance, the fluid reservoir is configured to cause the elastomer layer to vibrate at a higher mode of resonance relative to the metallic diaphragm.

Embodiment 8 includes the haptic actuator assembly of any one of embodiments 1-7. In the embodiment, the haptic actuator assembly further comprises a mounting structure and a block, wherein the actuator is disposed between the mounting structure and the rod, and wherein the block is directly attached to the second layer of the fluid reservoir and is able to vibrate together with the second layer.

Embodiment 9 includes the haptic actuator assembly of any one of embodiments 2-8. In the embodiment, the elastomer layer has a thickness that is at least five times higher than a thickness of the metallic diaphragm.

Embodiment 10 includes the haptic actuator assembly of any one of embodiments 2-9. In the embodiment, the metallic diaphragm has a thickness that is in a range of 0.02 mm to 0.08 mm.

Embodiment 11 includes the haptic actuator assembly of any one of embodiments 2-9. In the embodiment, a spring constant of the metallic diaphragm is higher than a spring constant of the elastomer layer.

Embodiment 12 includes the haptic actuator assembly of any one of embodiments 1-11. In the embodiment, the actuator is a piezoelectric actuator.

Embodiment 13 includes the haptic actuator assembly of any one of embodiments 1-12. In the embodiment, the haptic actuator assembly further comprises an object directly attached to the second layer, wherein the object has a mass that is in a range of 1 g to 10 g.

Embodiment 14 includes the haptic actuator assembly of any one of embodiments 1-13. In the embodiment, the haptic actuator assembly has a mass that is in a range of 20 g to 100 g when the fluid reservoir is empty of the substantially non-compressible fluid.

Embodiment 15 includes the haptic actuator assembly of any one of embodiments 1-14. In the embodiment, an area of the first layer is larger than an area of the second layer.

Embodiment 16 includes the haptic actuator assembly of any one of embodiments 1-15. In the embodiment, the fluid reservoir has a cavity and an inlet connected to the cavity, wherein the inlet is provides a passage for transferring additional fluid from an external source to the cavity.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A haptic actuator assembly, comprising:
a fluid reservoir configured to hold a substantially non-compressible fluid, the fluid reservoir having a first layer disposed on a first side of the fluid reservoir, and having a second layer that is less rigid than the first layer and disposed on a second side of the fluid reservoir that is opposite of the first side, wherein the first layer has a first resonance frequency and the second layer has a second resonance frequency lower than the first resonance frequency; and
an actuator mechanically coupled to the first layer of the fluid reservoir, the actuator being configured to cause a first vibration in which the first layer vibrates at the first resonance frequency and provides a first amount of displacement or acceleration of the first layer, and
wherein the fluid reservoir, when filled with the substantially non-compressible fluid, is configured to transfer a force of the first vibration from the first layer to the second layer to cause a second vibration in which the second layer vibrates at the second resonance frequency and provides a second amount of displacement or acceleration of the second layer that is higher than the first amount of displacement or acceleration of the first layer.

2. The haptic actuator assembly of claim 1, wherein the first layer of the fluid reservoir is a circular metal layer that forms a metallic diaphragm, and the second layer of the fluid reservoir is an elastomer layer.

3. The haptic actuator assembly of claim 2, wherein the elastomer layer is a silicone layer.

4. The haptic actuator assembly of claim 2, wherein the metallic diaphragm is mechanically coupled to the actuator by a rod disposed therebetween, wherein the actuator is configured to generate an initial vibration in which the actuator vibrates, wherein the rod is substantially rigid and is configured to transfer a force of the initial vibration to a center of the metallic diaphragm to cause an elastic deformation thereof, and wherein the elastic deformation of the center of the metallic diaphragm causes the first vibration, and the first vibration is configured to generate a pressure pulse that travels through the substantially non-compressible fluid to cause the second vibration.

5. The haptic actuator assembly of claim 4, wherein the first amount of displacement of the first layer provided by the first vibration is less than 350 um, and the second amount of displacement of the second layer provided by the second vibration is more than 1 mm.

6. The haptic actuator assembly of claim 4, wherein the initial vibration has a frequency that is in a range of 5 KHz to 10 KHz, and wherein the second resonance frequency at which the second layer of the fluid reservoir vibrates during the second vibration is in a range of 100 Hz to 300 Hz.

7. The haptic actuator assembly of claim 4, wherein, when the elastic deformation is generated by the metallic diaphragm vibrating at a lowest mode of resonance, the fluid reservoir is configured to cause the elastomer layer to vibrate at a higher mode of resonance relative to the metallic diaphragm.

8. The haptic actuator assembly of claim 4, further comprising a mounting structure and a block, wherein the actuator is disposed between the mounting structure and the rod, and wherein the block is directly attached to the second layer of the fluid reservoir and is able to vibrate together with the second layer.

9. The haptic actuator assembly of claim 2, wherein the elastomer layer has a thickness that is at least five times higher than a thickness of the metallic diaphragm.

10. The haptic actuator assembly of claim 9, wherein the metallic diaphragm has a thickness that is in a range of 0.02 mm to 0.08 mm.

11. The haptic actuator assembly of claim 9, wherein a spring constant of the metallic diaphragm is higher than a spring constant of the elastomer layer.

12. The haptic actuator assembly of claim 1, wherein the actuator is a piezoelectric actuator.

13. The haptic actuator assembly of claim 1, further comprising an object directly attached to the second layer, wherein the object has a mass that is in a range of 1 g to 10 g.

14. The haptic actuator assembly of claim 1, wherein the haptic actuator assembly has a mass that is in a range of 20 g to 100 g when the fluid reservoir is empty of the substantially non-compressible fluid.

15. The haptic actuator assembly of claim 1, wherein an area of the first layer is larger than an area of the second layer.

16. The haptic actuator assembly of claim 1, wherein the fluid reservoir has a cavity and an inlet connected to the cavity, wherein the inlet is provides a passage for transferring additional fluid from an external source to the cavity.
